(19) United States
(12) Patent Application Publication
(10) Pub. No.: US 2026/0329899 A1
(43) Pub. Date: Oct. 22, 2026

(54) Method and Visual System for Generating Treasure Locations

(71) Applicant: Kristina Rodiguez, Salem, OH (US)

(72) Inventor: Kristina Rodiguez, Salem, OH (US)

(21) Appl. No.: 18/831,556

(22) Filed: Apr. 21, 2025

(51) Int. Cl. G06F 16/29

(52) U.S. Cl. CPC G06F 16/29

(57) ABSTRACT

A computer program designed for treasure hunting, associated with electronic data configuration and spatial coordination analysis to find treasures buried underground, a visual portrayal of analyzed figures, and applying them to the field of treasure hunting to pinpoint a treasure's exact location before excavation.

### TECHNICAL FIELD

The disclosure is generally associated with electronic data configuration and spatial coordination analysis. More specifically, the disclosure relates to generating a visual portrayal of analyzed figures and applying them to the field of treasure hunting.

### BACKGROUND

Prior art in treasure hunting has used various methods for locating buried treasures or hidden objects underground, including metal detectors, ground penetrating radar, and deciphering treasure maps to name a few methods. However, these are limited in scope or knowledge and require significant expertise to find the exact location of a treasure or buried objects underground.

A computer program that collects huge amounts of data from multiple data sources predicting the location of the hidden treasure or buried objects underground; consisting of a consolidated system for aggregating huge amounts of data from disparate data sources, performing analysis, and generating meaningful and easy interpretable visual representations of the data to locate treasures and buried objects underground.

The present invention provides a practical solution to the problem of finding hidden treasure or buried objects under the ground. Traditional means of finding treasures and buried objects often don't always produce results. Using electronic data configuration and spatial coordinates, mathematical concepts and landmark formations can identify the locations of treasures or buried objects.

### SUMMARY

The aspects illustrated provide a computer-implemented method for representing data. The method aggregates data from multiple sources, which may be organized in multiple formats. The data is converted to a predetermined format followed by its, storage in a database. The data is analyzed, including input and outputs that pertain to spatial coordinates and geographical factors, and visual representations of the analyzed data are generated based on one or more predetermined parameters.

More components of the present disclosure describe a computer-implemented system for visual representation of data. The system includes a data aggregation module for aggregating data from multiple sources, which may be organized in multiple formats. The system further includes a data storage module, which includes a centralized database for storing the aggregated data, which is converted to a predetermined format before storage. An analysis module associates data elements and analysis outputs with one or more geographical factors. The system employs a network for transmitting the analyzed data and generating treasure locations using the system.

### BRIEF DESCRIPTION OF THE DRAWINGS

The drawing figures described below set out and illustrate several exemplary embodiments of the disclosure. The drawings are illustrative and are not drawn to scale.

FIG. 1 shows a visual representation of the computer system needed for computer vision image recognition and generation to perform the computer application.

FIG. 2 is a flowchart of an exemplary computer-implemented method of steps involved in generating treasure location coordinates written in Java.

FIG. 3 illustrates the mathematical concept of the invention.

### DETAILED DESCRIPTION

A computer system for generating treasure coordinates written in Java. The method collects data from varied data sources organized in multiple data configurations. The data is converted to a set format and stored in a database. The data is analyzed by correlating data elements and analysis outputs with geographical factors and spatial coordinates. The method generates visual representations of analyzed figures.

The following detailed description is made concerning, the figures and drawings. Exemplary embodiments are described to illustrate the subject matter of the disclosure, not to limit its scope, which is defined by the appended claims.

### TERMS

These terms are used in this document and are defined to clarify.

### Disparate Data Origin

The term ‘disparate data origin’ represents different origins of data, which can be any device or network location capable of providing access to data of a particular data type. Aggregating data sources which may be organized in multiple data formats. The data is then converted to a predetermined format before being stored in the database. Enabling the system to analyze and associate data elements and analyze outputs with geographical spatial coordinates and visual representations of analyzed data ultimately leads to generation and output based on predetermined parameters.

### Extranet

The external networks or databases the computer program accesses in real time to gather information for the treasure location prediction.

### Information Feed

Information feed is an electronic transmission of data to external databases and APIs used to obtain relevant information. It is a mechanism for users to present updated data from data sources. It is commonly used by real-time applications of weather patterns in a variety of formats which need to be converted to stand format.

### Coordinate Representation

Coordinate representation is a virtual globe, or visually mapping out data collected or geographic descriptions that produce high compression ratios. The geospatial representation display is set to see patterns and relationships within the data.

### Java Database Connectivity (JDBC)

JDBC is an application programming interface (API) independent connection between the Java programming language and a vast range of databases-in real-time-by providing a standard interface for obtaining diverse types of: data sources. JDBC enables the extraction of valuable information, incorporating it into the decision-making process. It is an adaptable system that works on various types of data, allowing it to function across different applications.

### DESCRIPTION OF EXAMPLE EMBODIMENTS

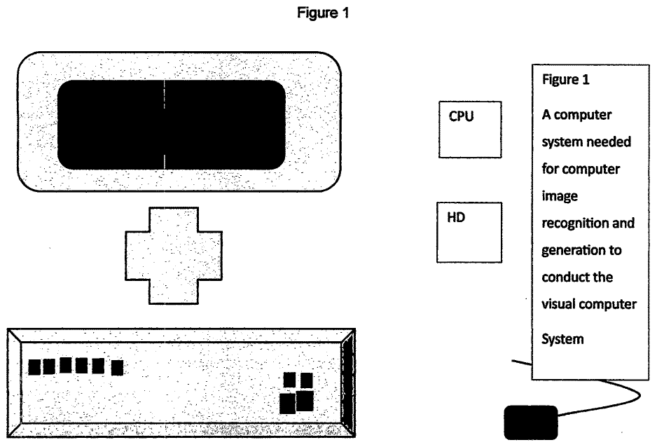

FIG. 1 illustrates the visual representation of a CPU/HD analytical computer system to aggregate data sources.

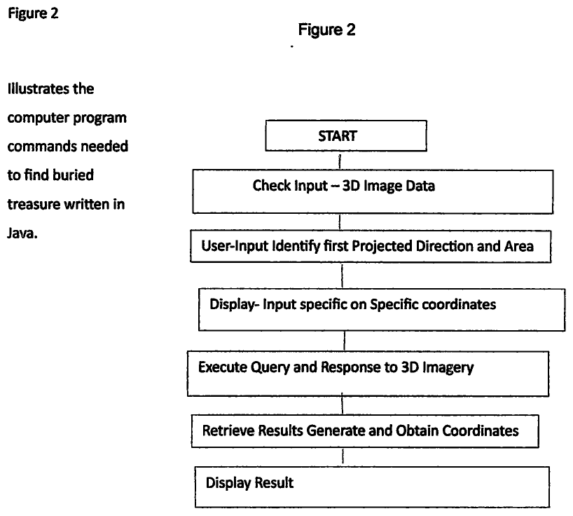

FIG. 2 illustrates a flowchart of methods used to generate data, using spatial processing 3D images with user input, displaying user input specifics like: finding the coordinates of treasures located underground by analyzing 3D imagery of locations and history records, retrieving and generating results then displaying results.

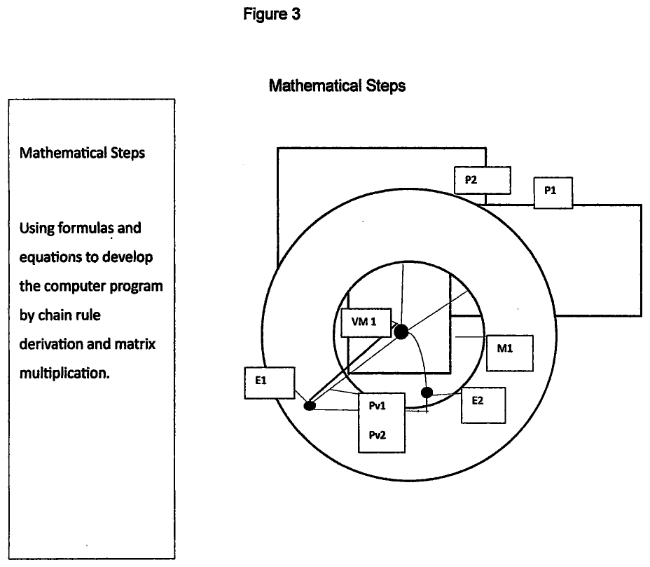

FIG. 3 is the mathematical concept used in creating the computer system, using formulas and equations by chain rule derivation and matrix multiplication.

1. A computer system for data collection and usage for generating treasure locations and other hidden items buried underground. Consists of steps of aggregating disparate data sources; converting collected data into standard format; and identifying patterns and correlations within said data.

2. The computer-implemented method consists of non-transitory storage, medium storing, and computer-executable instructions for implementing the method according to claim 1.

3. The computer-implemented method of claim 2, when determining the spatial coordinates.

4. The computer-implemented method of claim 3, further comprises the steps of spatial processing and the collecting data to remove irrelevant information and enhance the accuracy of the recognition process.

5. The computer-implemented method of claim 4, further comprising of steps of aggregating the recommended locations into a prioritized list and proprietary software used to execute the search process.

6. The inventor holds exclusive rights to the process of, developing and implementing, this computer system and its software designed to locate and recover hidden treasure using a combination not limited to historical records, geographical sites, and spatial coordinates.

7. The inventor holds exclusive rights to the process of developing and implementing this computer system and method designed to locate hidden treasure underground and can be modified to find any hidden object underground and any features or improvements can made to the computer system in the future.
